(19) United States
(12) Patent Application Publication
(10) Pub. No.: US 2026/0205312 A1
(43) Pub. Date: Jul. 16, 2026

(54) DATA PROCESSING DEVICE AND METHOD FOR ASSIGNING AUTHORIZATION TO MANAGE THE DATA PROCESSING DEVICE

(71) Applicant: WAGO Verwaltungsgesellschaft mbH, Minden (DE)

(72) Inventors: Falk WERNER, Minden (DE); Marius WARNING, Lindau (DE); Simon DICK, Espelkamp (DE)

(73) Assignee: WAGO Verwaltungsgesellschaft mbH, Minden (DE)

(21) Appl. No.: 19/448,503

(22) Filed: Jan. 14, 2026

(30) Foreign Application Priority Data
Jan. 14, 2025 (DE) 10 2025 101 014.5

(51) Int. Cl. H04L 9/32

(52) U.S. Cl. CPC H04L 9/3263; H04L 9/3247

(57) ABSTRACT

Provided is a data processing device and a method for assigning an authorization to manage a data processing device comprising receiving, by the data processing device, first data, determining, by the data processing device, a source of the first data based on an encryption of at least a part of the first data, a certificate provided with the first data, and/or a signature of the first data, and assigning, by the data processing device, the authorization to manage the data processing device to the source.

This nonprovisional application claims priority under 35 U.S.C. § 119(a) to German Patent Application No. 10 2025 101 014.5, which was filed in Germany on January 14, 2025, and which is herein incorporated by reference.

### BACKGROUND OF THE INVENTION

### Field of the Invention

The present invention relates to data processing devices and methods for assigning an authorization to manage the data processing devices. In particular, the present invention relates to methods for assigning an authorization to manage the data processing devices by means of encryptions, certificates, and/or signatures.

### Description of the Background Art

To facilitate the putting into operation of a data processing device by the user (customer), the data processing device may be pre-configured during manufacturing so that, upon startup, the data processing device, using a unique identifier, logs onto a portal (operated by the customer, manufacturer, or a third party) which provides the data processing device with a current firmware and/or configures the data processing device individually for the user. Depending on the situation, the portal may be provided in an intranet of the user which is not accessible to the public or the publicly accessible Internet (by the manufacturer or a third-party provider). In particular, if the portal is provided on the Internet, it may be advantageous to secure the interaction between the data processing device and the portal against unauthorized access.

### SUMMARY OF THE INVENTION

It is therefore an objection of the invention to provide a method that, in an example, comprises the steps of: receiving, by a data processing device, first data; determining, by the data processing device, a source of the first data based on an encryption of at least a part of the first data, a certificate provided with the first data, and/or a signature of the first data; and assigning, by the data processing device, an authorization to manage the data processing device to the source. The method may further comprise processing, by the data processing device, the first data. For example, the first data may comprise information on the putting into operation and/or configuration of the data processing device, and/or software to be executed by the data processing device, and/or an update to the software to be executed by the data processing device.

In this regard, the term "data processing device" can refer to a device comprising a processor and non-volatile memory, wherein machine-readable instructions are stored in the memory, the execution of which by the processor causes data to be read and processed. The data may be, for example, state data that describes the state of a plant controlled by the data processing device or by a system that comprises the data processing device, and the data processing device may be configured to derive control data for controlling the plant from state data and/or to forward state data to a higher-level control system, which determines control data for controlling the plant based on the state data. The data processing device may be configured with respect to deriving and/or forwarding state data during the putting into operation.

Furthermore, the term "data network" can refer to a decentralized network comprising several nodes and data lines connecting the nodes, such as the Internet or a (non-public) intranet. Moreover, the term "server", can refer to a node of the data network which provides one or more services to (authorized) nodes of the data network. Said services may be used by the (authorized) nodes of the data network in that an (authorized) node sends a corresponding request to the server, and the server determines that the node is authorized to request the service. The service may, for example, include the server providing certain data to the node (requesting the service).

Furthermore, the term “encryption”, can refer to the conversion of plain data into encrypted data, which constitute the data or a part of the data, by means of a secret key (“private key”). Reverse conversion using a public key allows the source of the first data to be determined. In this context, the term "source" can refer to to a person or an entity that is lawfully in possession of the secret signature key and has encrypted at least a part of the first data or according to whose instructions at least the part of the first data has been encrypted.

Moreover, the term "certificate", can refer to a data structure comprising a public key and identity information of a person, entity, or domain to which the public key is assigned by a Certification Authority (CA). The certificate may be signed with a secret key of the CA, which thereby guarantees the authenticity of the certificate. In this context, the term "source" can refer to the person, entity, or domain that is recorded in the certificate. For example, the certificate may have a field called Common Name (CN) and contain a domain that is owned by a specific person or entity.

Furthermore, the term "signature" can refer to a value calculated over a hash value (derived from at least a part of the first data) using a secret signature key, which enables the verification of the usage of the secret signature key by applying a public verification key. In this context, the term "source" can refer to a person or entity that is in lawful possession of the secret signature key.

Moreover, the phrase that "a source is authorized to manage the data processing device," can mean that the data processing device will only apply data comprising information on the putting into operation and/or configuration of the data processing device, and/or software to be executed by the data processing device, and/or updates to the software to be executed by the data processing device, if the data originates from the source and will discard data if it does not originate from the source.

For example, before receiving the first data, a data field in the data processing device intended to store the authorized source may be empty or pre-filled with a default value, so that the data processing device is ready to accept data directed at managing the data processing device from any source. After receiving the first data, if the data field is populated, the data processing device may only accept data directed at managing the data processing device from the source. The data processing device may further comprise a manually operated element (e.g. a button), the operation of which causes an entry to be deleted (or a default value to be restored) in the data field. This allows for reassigning the data processing device and the authorized source.

Determining the source of the first data may be based on the certificate or the signature. For example, the first data may comprise a certificate and be signed based on a secret signature key associated with the certificate. In particular, determining the source of the first data may be based on a name in the certificate. For example, determining the source of the first data may be based on the CN in the certificate.

The method may further comprise receiving, by the data processing device, second data, determining, by the data processing device, a source of the second data based on an encryption of at least a part of the second data, a certificate provided with the second data, and/or a signature of the second data, and, if the first data and the second data originate from the same source, processing, by the data processing device, the second data.

The second data may comprise information on the putting into operation and/or configuration of the data processing device, and/or software to be executed by the data processing device, and/or an update to the software to be executed by the data processing device.

A data processing device according to the invention may comprise a processor and a non-volatile memory, wherein machine-readable instructions are stored in the memory, the execution of which by the processor causes the data processing device, when the data processing device is put into operation, to contact a server via a data network and receive first data, determine a source of the first data on the basis of an encryption of at least a part of the first data, a certificate provided with the first data, and/or a signature of the first data, and designate the source as authorized to manage the data processing device.

Determining the source of the first data may be based on the certificate or the signature. For example, the first data may comprise a certificate and be signed based on a secret signature key associated with the certificate. In particular, determining the source of the first data may be based on a name in the certificate. For example, determining the source of the first data may be based on the CN in the certificate.

Furthermore, the execution of the machine-readable instructions stored in memory by the processor may cause the data processing device to contact the server via the data network and receive second data, determine a source of the second data based on an encryption of at least a part of the second data, a certificate provided with the second data, and/or a signature of the second data, and process the second data if the second data originates from the same source as the first data.

The first data and/or the second data may comprise information for configuring the data processing device and/or software to be executed by the data processing device and/or an update of the software to be executed by the data processing device.

Moreover, it is understood that all features described in connection with the method may also be features of the data processing device and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a server and a data processing device which receives first data from the server;

FIG. 2 shows a flowchart of steps for determining and designating a source as authorized to manage the data processing device;

FIG. 3 shows the server, the data processing device, and the first data according to an example;

FIG. 4 shows the server, the data processing device, and the first data according to an example;

FIG. 5 shows the server, the data processing device, and the first data according to an example;

FIG. 6 shows the generation of a certificate according to an example; and

FIG. 7 shows a flowchart of a method for assigning an authorization to manage the data processing device.

### DETAILED DESCRIPTION

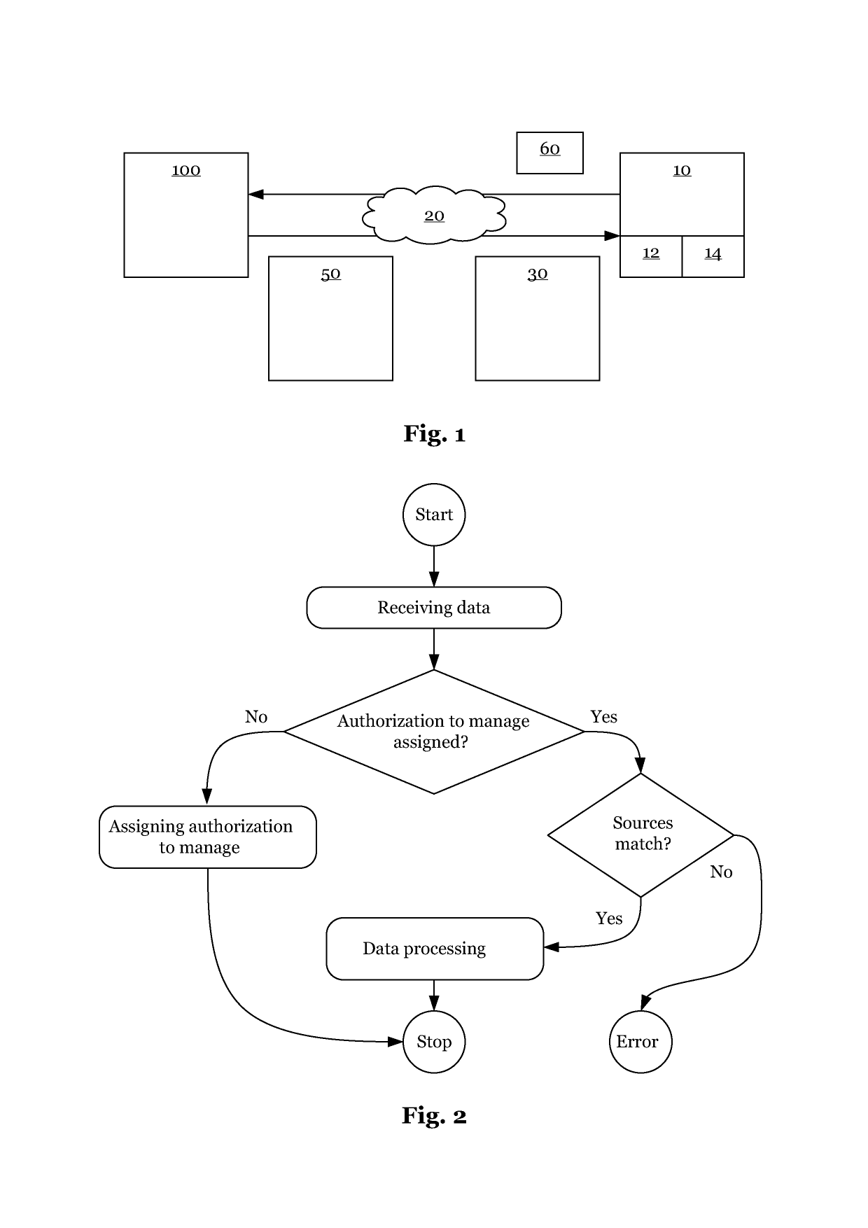

FIG. 1 shows a data processing device 10 which comprises a processor 12 and a memory 14. The data processing device 10 may, for example, comprise a microcontroller and be a fieldbus coupler or an input/output module of a modular fieldbus node. When the data processing device 10 is put into operation, the data processing device 10 sends a message 60 via a data network 20 to a server 100 which hosts a portal. This message 60 identifies the data processing device 10 and is interpreted by the server 100 as a request to provide data 30 available at the server 100 (or another server) that relates to the authorization to manage the data processing device 10. The data 30 will be used by the data processing device 10 to determine who is authorized to manage the data processing device 10 from now on. Data received thereafter may be checked to determine whether the data originates from a source that is authorized to manage the data processing device 10.

As shown in FIG. 2, the data processing device 10 may check, upon receiving the data 30, whether a source has already been designated as authorized to manage the data processing device 10. If this is not the case, the data processing device 10 may determine the source of the data 30 based on an encryption of at least a part of the data 30, a certificate provided with the data 30, and/or a signature of the data 30, and designate the source as authorized to manage the data processing device 10. Furthermore, the data processing device 10 may process the data 30. If the data 30 comprises information on the configuration of the data processing device 10, the configuration may be applied. If the data 30 comprises software to be executed by the data processing device 10 (e.g., firmware and/or one or more customer-specific applications), the software may be stored in the memory 14 and executed. If the data 30 comprises an update to the software executed by the data processing device 10, the software may be updated.

If further data 50 is received that is directed at managing the data processing device 10, e.g., data 50 containing information on the configuration of the data processing device 10, and/or software to be executed by the data processing device 10, and/or an update to the software to be executed by the data processing device 10, the data processing device 10 may determine the source of the data 50 based on an encryption of at least a part of the data 50, a certificate provided with the data 50, and/or a signature of the data 50, and verify whether the source of the data 50 is authorized to manage the data processing device 10. If the source of the data 50 is authorized to manage the data processing device 10, the data 50 may be processed. If the data 50 comprises information on the configuration of the data processing device 10, the configuration may be applied. If the data 50 comprises software to be executed by the data processing device 10, the software may be stored in the memory 14 and executed. If the data 50 comprises an update to the software executed by the data processing device 10, the software may be updated.

If the source of the data 50 is not authorized to manage the data processing device 10, the data processing device 10 may notify the server 100 of the error with a message and discard the data 50. On the server side, the data 50 may then be checked and corrected if necessary. In the event that the data 50 was not provided by server 100 (or any other server) but originates from a source not authorized to manage the data processing device 10, further measures may be taken to make future attempts regarding the unauthorized management of the data processing device 10 (more) difficult.

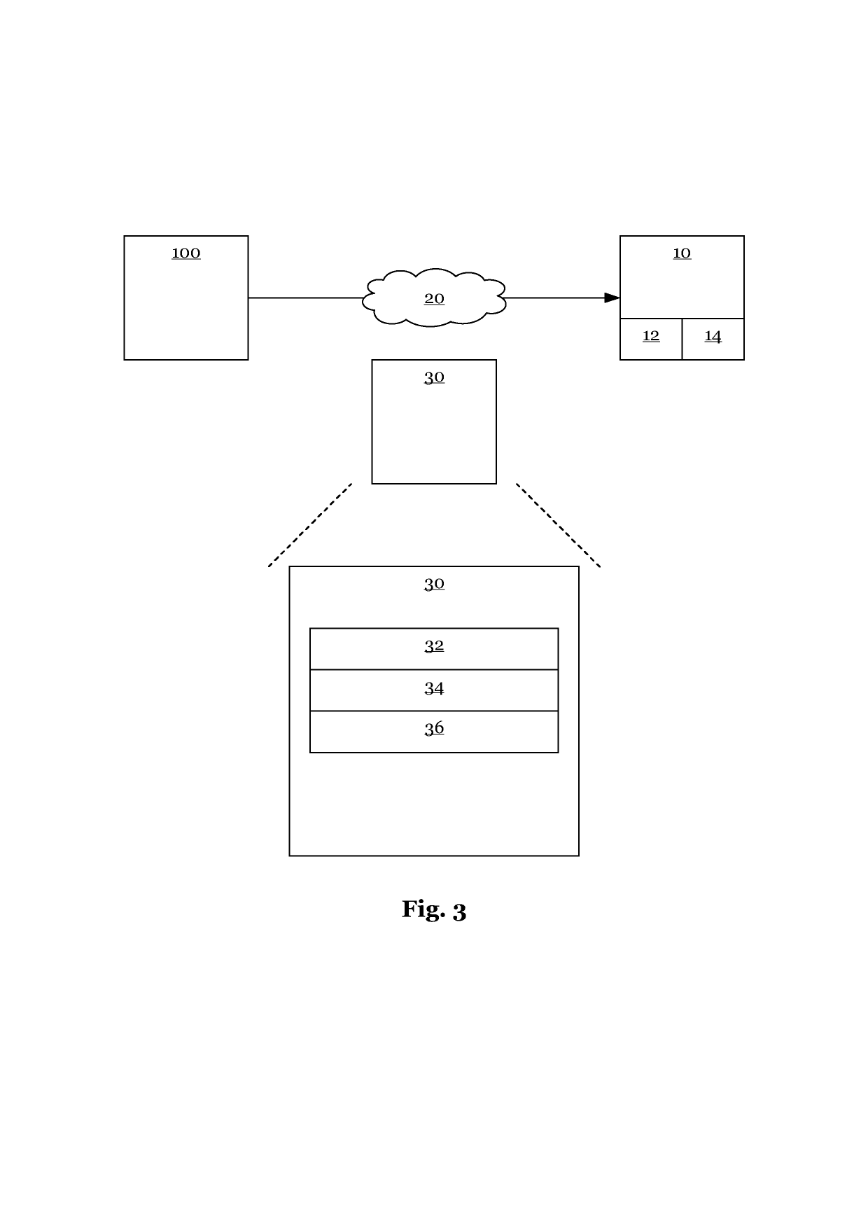

FIG. 3 shows data 30 according to a first example. In this example, the data 30 comprises information 32 on the putting into operation and/or the configuration of the data processing device 10, a software and/or software update 34, and information 36 on the source. The information on the source may be encrypted with a secret key assigned to the source, so that the authenticity of the information can be verified by the data processing device 10 with a (public) verification key assigned to the source.

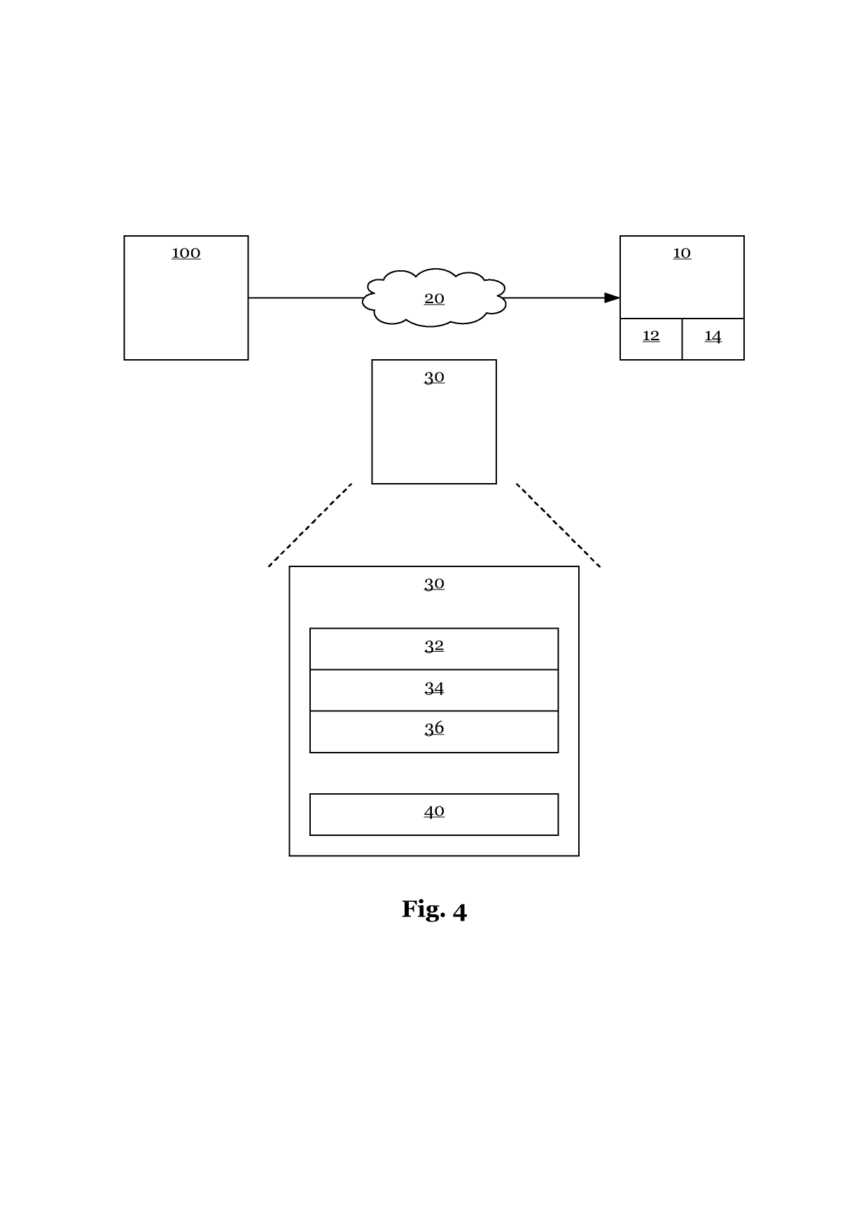

FIG. 4 shows data 30 according to a second example. In this example, the data 30 comprises information 32 on the putting into operation and/or the configuration of the data processing device 10, a software and/or software update 34, information 36 on the source, and a signature 40. The authenticity of the information may be verified by the data processing device 10 with a (public) verification key associated with the signature.

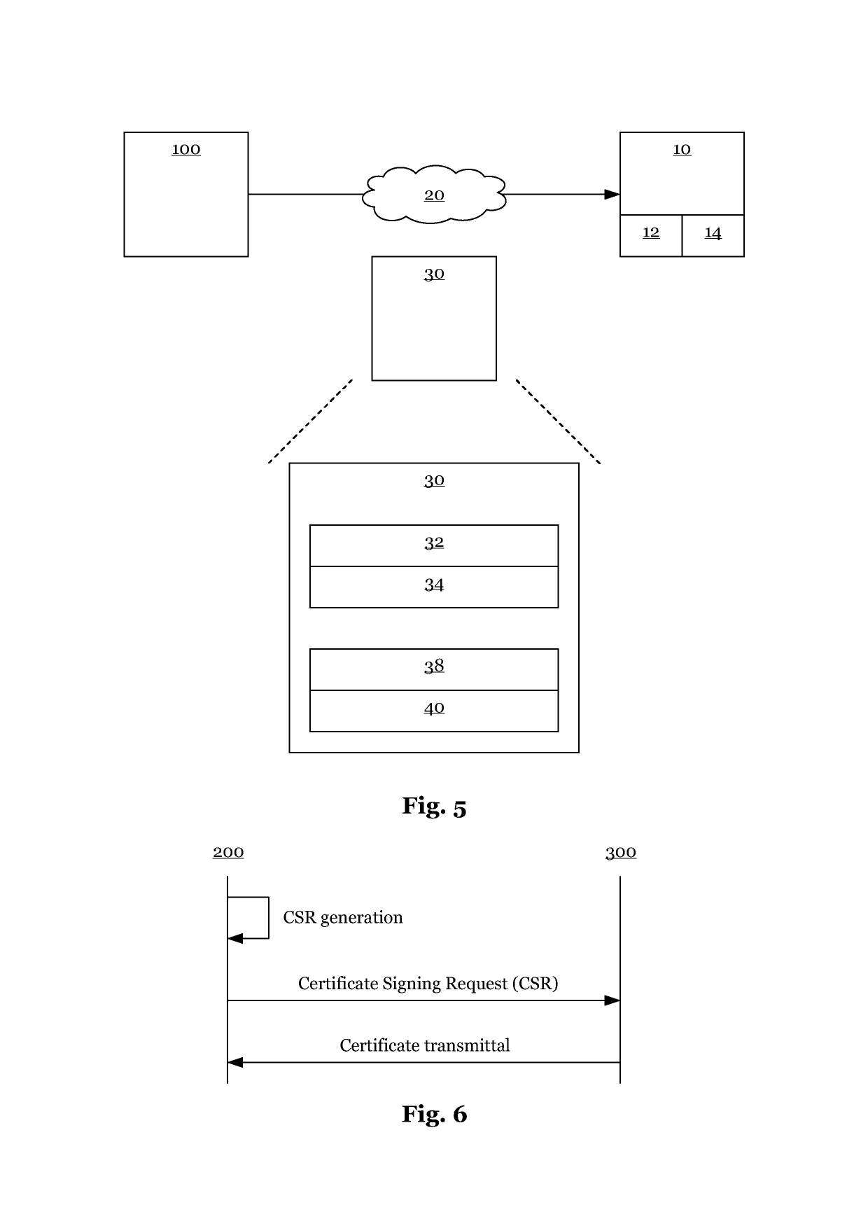

FIG. 5 shows data 30 according to a third example. In this example, the data 30 comprises information 32 on the putting into operation and/or the configuration of the data processing device 10, a software and/or software update 34, a certificate 38, and a signature 40. The authenticity of the certificate 38 may be verified by the data processing device 10 with a (public) verification key assigned to the signature 40, and the data processing device 10 may extract information about the source from the certificate 38.

FIG. 6 shows a process for creating the certificate 38 according to an example. In this example, the source 200 (e.g., the end customer or a third-party provider instructed by the end customer) creates a Certificate Signing Request (CSR) and sends the CSR to the manufacturer 300 (or a third-party provider instructed by the manufacturer 300), who generates a certificate and transmits the certificate to the source. Since the secret key of the source 200 remains with the source, the fact that the information is encrypted with the secret key serves as strong evidence that the information originates from the source 200.

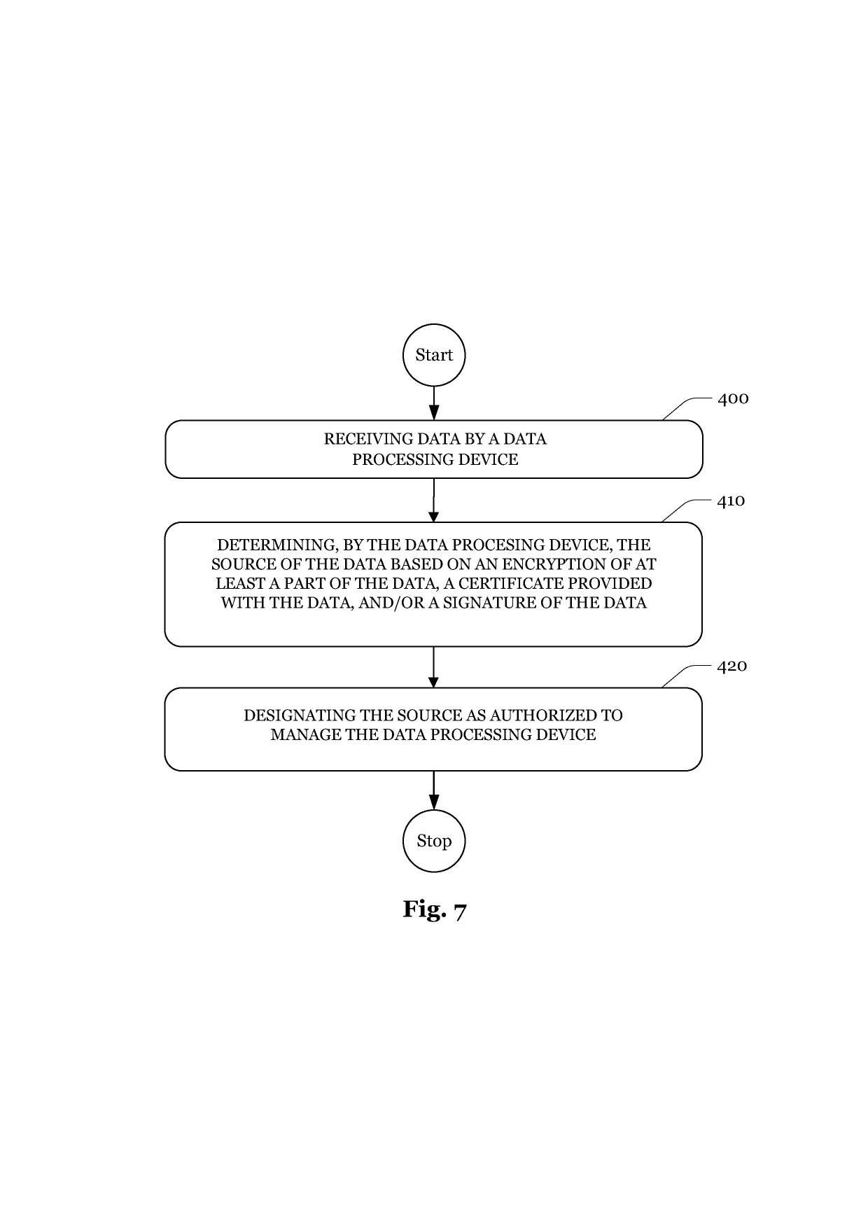

FIG. 7 shows a flowchart of a method for assigning an authorization to manage the data processing device 10. The method starts at step 400 with receiving the data 30 by the data processing device 10. In response to receiving the data 30, the data processing device 10 determines the source 200 of the data 30 in step 410 based on an encryption of at least a part of the data 30, a certificate 38 provided with the data 30, and/or a signature 40 of the data 30. If no source has yet been designated as authorized to manage the data processing device 10, the data processing device 10 designates the source 200 as authorized to manage the data processing device 10 in step 420.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to assign an authorization to manage a data processing device comprising a processor and non-volatile memory, the method comprising:
receiving first data by the data processing device;
determining, by the data processing device, a source of the first data based on an encryption of at least a part of the first data, a certificate provided with the first data, and/or a signature of the first data; and
assigning, by the data processing device, the authorization to manage the data processing unit to the source.

2. The method for assigning an authorization to manage a data processing device of claim 1, wherein the determining the source of the first data is based on the certificate or the signature.

3. The method for assigning an authorization to manage a data processing device of claim 2, wherein the determining the source of the first data is based on a name in the certificate.

4. The method for assigning an authorization to manage a data processing device of claim 1, further comprising:
receiving, by the data processing device, second data;
determining, by the data processing device, a source of the second data based on an encryption of at least a part of the second data, a certificate provided with the second data, and/or a signature of the second data; and
processing, if the first data and the second data originate from the same source, the second data by the data processing device.

5. The method for assigning an authorization to manage a data processing device of claim 1, wherein the first data and/or the second data comprise information on putting into operation and/or the configuration of the data processing device, and/or software to be executed by the data processing device, and/or an update of the software to be executed by the data processing device.

6. A data processing device comprising:
a processor; and
a non-volatile memory, wherein machine-readable instructions are stored in the non-volatile memory, an execution of which by the processor causes the data processing device:
to contact a server via a data network and to receive first data when the data processing device is put into operation,
to determine a source of the first data based on an encryption of at least a part of the first data, a certificate is provided with the first data and/or a signature of the first data, and
to designate the source as authorized to manage the data processing device.

7. The data processing device of claim 6, wherein, the determination of the source of the first data is based on the certificate or the signature.

8. The data processing device of claim 7, wherein the determination of the source of the first data is based on a name in the certificate.

9. The data processing device of claim 6, wherein the execution of the machine-readable instructions stored in the memory by the processor further causes the data processing device:
to contact the server via the data network and receive second data;
to determine a source of the second data based on an encryption of at least a part of the second data, a certificate provided with the second data, and/or a signature of the second data; and
to process the second data if the second data originates from the same source as the first data.

10. The data processing device of claim 9, wherein the first data and/or the second data comprise information to configure the data processing device and/or software to be executed by the data processing device and/or an update of the software to be executed by the data processing device.
